(19) United States
(12) Patent Application Publication
(10) Pub. No.: US 2007/0251980 A1
(43) Pub. Date: Nov. 1, 2007

(54) REDUCED OXIDATION SYSTEM FOR WIRE BONDING

(76) Inventors: Gary S. Gillotti, Bensalem, PA (US); Steven Mak, Philadelphia, PA (US); E. Walter Frasch, Perkasie, PA (US)

Correspondence Address: KULICKE AND SOFFA INDUSTRIES, INC., 1005 VIRGINIA DRIVE, FORT WASHINGTON, PA, 19034, US

(21) Appl. No.: 11/380,233

(22) Filed: Apr. 26, 2006

(51) Int. Cl. B23K 37/00; B23K 35/38

(52) U.S. Cl. 228/4.5; 228/219; 228/180.5

(57) ABSTRACT

A wire bonding machine is provided. The wire bonding machine includes (1) a bond site area for holding a semiconductor device during a wire bonding operation, and (2) a gas supply line configured to provide a gas at the bond site area from above the bond site area.

### FIELD OF THE INVENTION

The present invention relates to wire bonding of semiconductor devices, and more particularly, to providing a cover gas to the bond site area of a wire bonding machine.

### BACKGROUND OF THE INVENTION

In the manufacturer of various semiconductor devices, wire bonding techniques are often used to connect components in the devices. For example, wire bonds (or wire loops) are often used to provide interconnection between a die and contacts on a leadframe. An exemplary conventional wire bonding operation involves (1) bonding to a first bonding location on a die (e.g., using ball bonding), (2) extending a wire toward a second bonding location on a leadframe, (3) bonding the end of the extended wire to the second bonding location, and (4) cutting the wire. In such ball bonding, an electronic flame off (i.e., EFO) wand or the like is typically used to form a “ball” (aka a free air ball) at the end of the wire.

Often, gold wire (which is substantially non-reactive with oxygen) is used in wire bonding processes; however, in certain applications, more reactive metals (e.g., copper, silver, palladium, aluminum, etc.) are used. These more reactive metals may react, for example, in the presence of oxygen and form oxides/oxidation on the wires (and/or wire ends or tails) which are undesirable for wire bonding.

In view of such potential oxidation, certain wire bonding systems include subsystems for providing a cover gas to the end of a wire during formation of the ball by the EFO wand. For example, U.S. Pat. No. 6,234,376, which is incorporated by reference in its entirety, discloses such a system.

Unfortunately, such cover gas subsystems do not protect the entire wire (or the entire duration of the wire bonding process) from potential oxidation, and as such, oxidation problems in wire looping with reactive metals still exists.

Thus, it would be desirable to provide a method and apparatus for reducing oxidation in wire bonding.

### SUMMARY OF THE INVENTION

According to an exemplary embodiment of the present invention, a wire bonding machine is provided. The wire bonding machine includes (1) a bond site area for holding a semiconductor device during a wire bonding operation, and (2) a gas supply line configured to provide a gas at the bond site area from above the bond site area.

In certain exemplary embodiments of the present invention, the wire bonding machine may also include (1) an electronic flame off wand and (2) an electronic flame off gas supply line. Such an electronic flame off gas supply line may be configured to provide a gas during formation of a ball on an end of a wire via the electronic flame off wand. The gas provided by the gas supply line and the electronic flame off gas supply line may be the same type of gas, and in fact, may be provided from the same gas source.

According to another exemplary embodiment of the present invention, a method of processing a semiconductor device is provided. The method includes providing a wire bonding machine including a bond site area for holding a semiconductor device during a wire bonding operation. The method also includes supplying a gas to the bond site area from above the bond site area during the wire bonding operation.

Portions of the method of the present invention may also be embodied as an apparatus (e.g., as part of the intelligence of a wire bonding machine), or as computer program instructions on a computer readable carrier (e.g., a computer readable carrier used in connection with a wire bonding machine).

### BRIEF DESCRIPTION OF THE DRAWINGS

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 is a perspective view of a portion of a wire bonding system in accordance with an exemplary embodiment of the present invention;

FIG. 2 is an exploded view of a gas tube in accordance with an exemplary embodiment of the present invention; and

FIGS. 3A-3H are block diagrams sequentially illustrating a process of reducing potential oxidation in a bond site area in accordance with an exemplary embodiment of the present invention.

### DETAILED DESCRIPTION OF THE INVENTION

U.S. Pat. Nos. 5,205,463, 6,062,462, and 6,156,990, as well as United States Patent Publication No. 2004/0152292, relate to wire bonding technology, and are herein incorporated by reference in their entirety.

As used herein, the term “gas supply line” refers to any structure (e.g., a gas supply tube such as tube 20 disclosed herein) configured to direct a gas (e.g., a cover gas such as nitrogen, argon, etc.) to a bond site area of a wire bonder. The term “gas supply line” is not intended to be limited to any particular configuration or design.

According to certain exemplary embodiments of the present invention, a gas (e.g., a cover gas such as a gas including nitrogen, argon) (where the gas may or may not include a reducing gas such as hydrogen) is provided in the vicinity of the bond site area of a wire bonding machine. For example, during a wire bonding operation, a constant supply of the gas may be provided at the bond site area such that during the wire bonding operation there is a reduced potential for oxidation of the wires. Depending upon the gas (and temperature) used, there may also be a reduction of oxide/oxidation already present on the wires, similar to the effect of applying a reducing gas during formation of a free air ball.

For example, during a wire bonding operation, after completing a wire loop (and prior to forming the next free air ball) a wire tail (e.g., the end portion of wire suspended from a capillary tip) may be subjected to oxygen or the like resulting in oxides forming on the wire tail. Such oxides may be undesirable for bonding, even if the wire tail is later formed into a free air ball. The present invention addresses such a situation by providing (in certain exemplary embodiments) a constant supply of cover gas in the bond site area such that the wire tail is protected from oxidation prior to formation of the next free air ball. The present invention also helps to protect against oxidation of the wire (and/or wire ends) during various other phases of the wire bonding cycle such as, for example, (1) when forming the second bond in the bond site area, (2) when lowering a formed free air ball to the bond site area, amongst others.

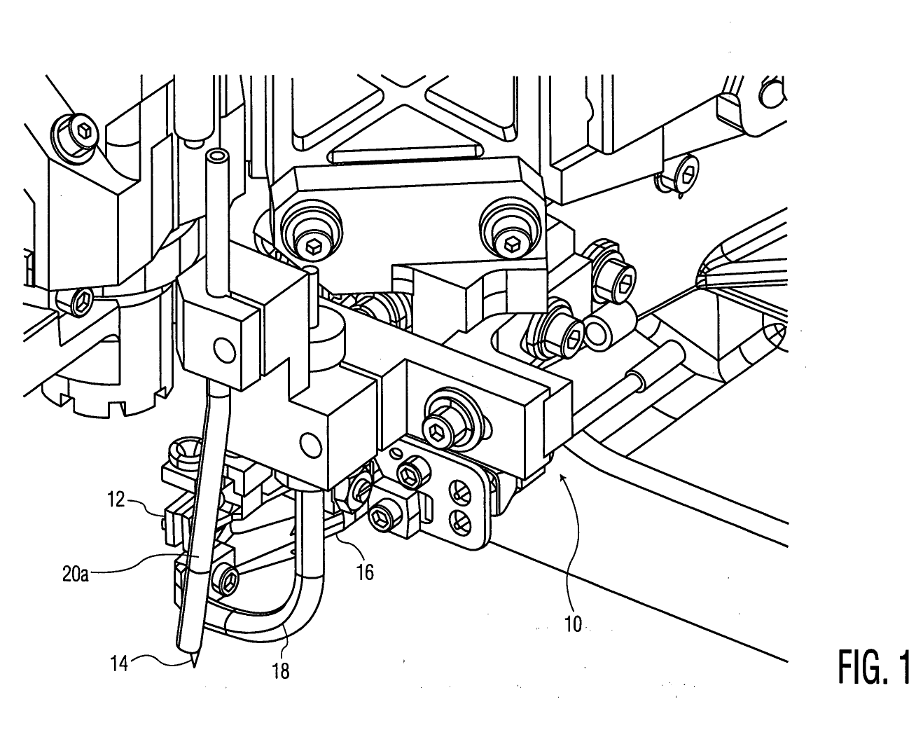

FIG. 1 is a perspective view of a portion of a wire bonding machine. Various features of wire bonding machines not illustrated or discussed in the present application are conventional in nature and understood by those of ordinary skill in the art.

FIG. 1 illustrates bond head 10 of a wire bonding machine. Bond head 10 supports wire clamp 12, transducer 16, capillary 14, electronic flame off gas supply tube 18, and gas supply tube 20a. The electronic flame off wand of the wire bonding machine is not visible in FIG. 1. As is understood by those skilled in the art, wire is provided through wire clamp 12 to capillary 14 for wire bonding using, for example, ultrasonic energy provided by transducer 16. Electronic flame off gas supply tube 18 is connected to a gas source (not shown) and provides a cover gas during formation of a ball at the end of a wire held by capillary 14. Particularly in applications using reactive metal wires (e.g., copper, aluminum, etc.) such a cover gas can help to protect against oxidation of the metal during formation of the ball.

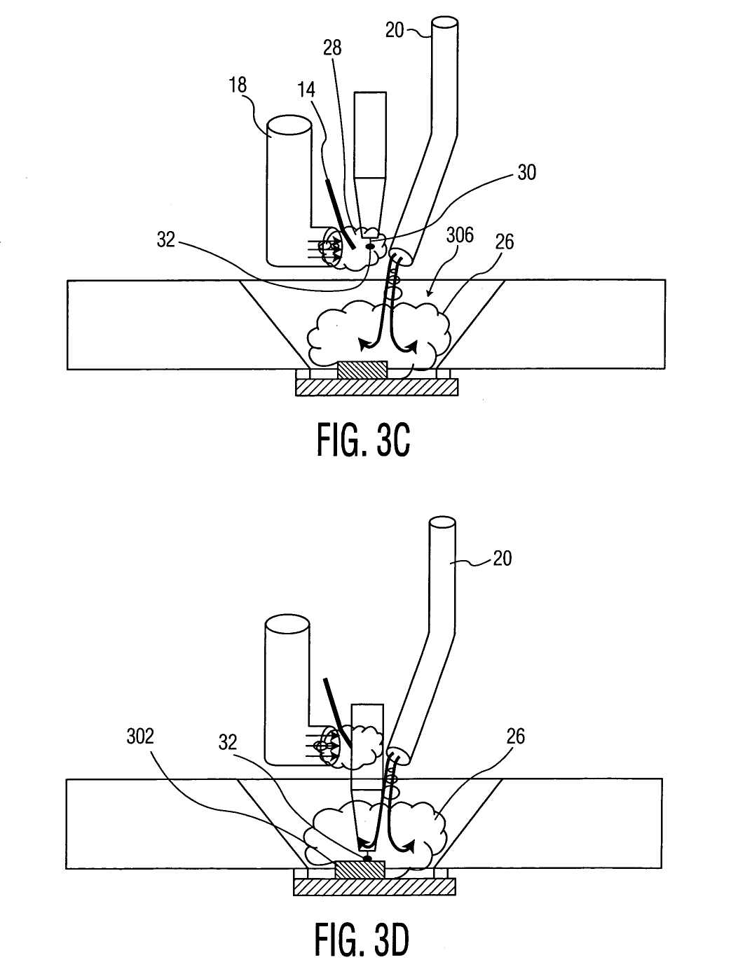

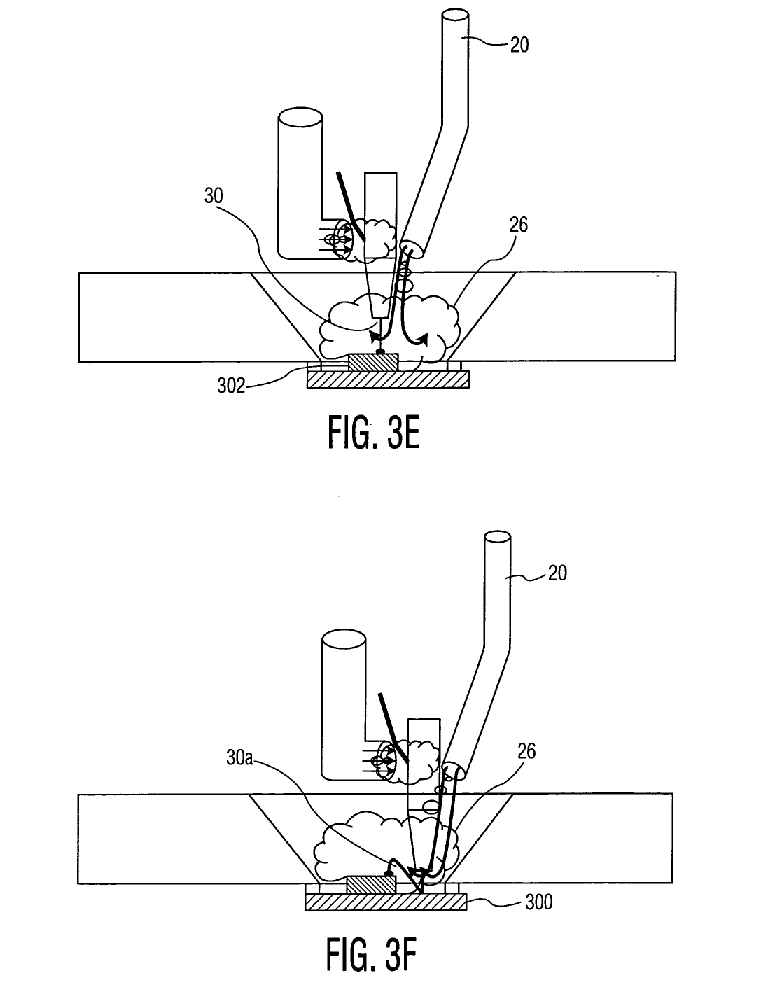

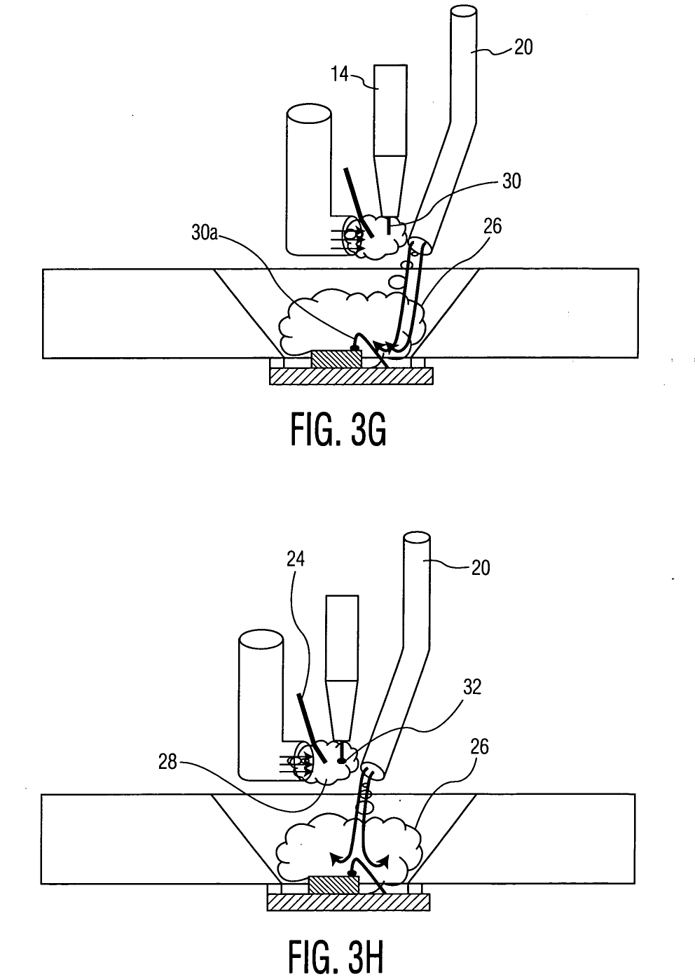

As will be explained in greater detail below with respect to FIGS. 3A-3H, gas supply tube 20a (which is oriented in a substantially vertical direction with its outlet opening pointing downward) provides a cover gas to the bond site area to protect against potential oxidation of the wire (and/or wire ends) during the wire bonding operation.

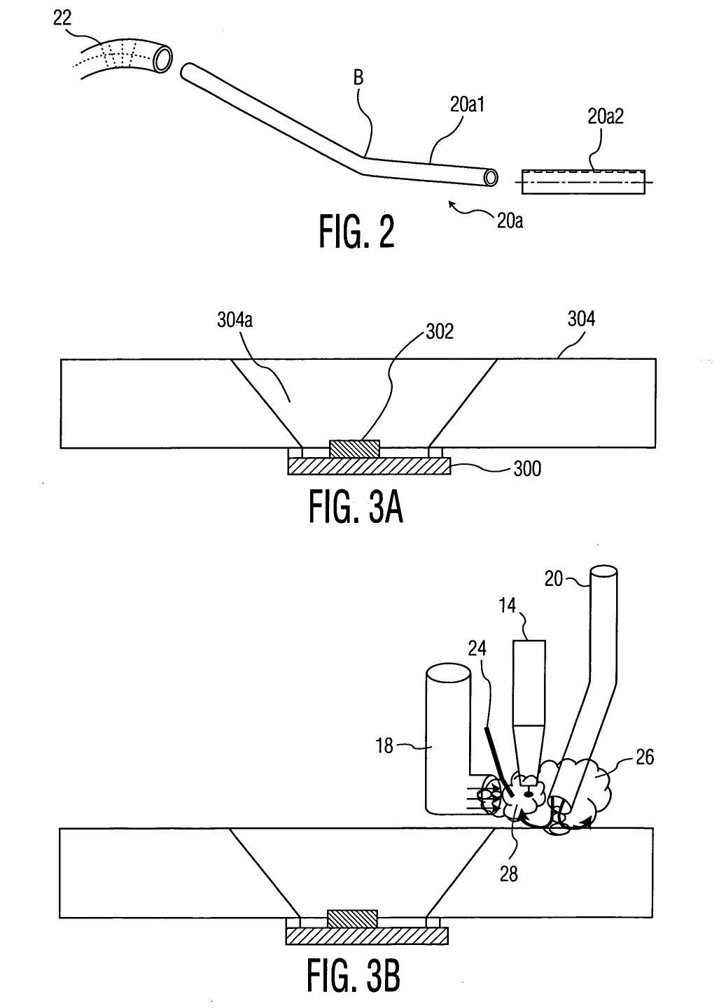

FIG. 2 is an exploded view of gas supply tube 20a including portion 20a1 and portion 20a2. In order to properly direct the cover gas flow without interfering with other portions of the wire bonding machine (and/or to facilitate support of gas supply tube 20a), portion 20a1 is provided with a bend “B.” For example, portion 20a1 may be formed of a metal such as, for example, stainless steel. In certain applications it may be undesirable to have a metallic tube adjacent the flame off process due to potential arcing and the like. As such, in the embodiment illustrated in FIGS. 1-2, gas supply tube 20a is a multi-part tube and includes portion 20a2 which may be formed of a non-conductive material, for example, polyimide. Further, portion 20a2 may be a replaceable component. FIG. 2 also illustrates a portion of gas piping/tubing 22 (connected to a gas supply source which is not illustrated) configured to be coupled to portion 20a1 of gas supply tube 20a.

Referring now to FIGS. 3A-3H, there is provided a series of block diagram views illustrating a method of processing a semiconductor device in accordance with an exemplary embodiment of the present invention. FIG. 3A illustrates semiconductor device 302 (e.g., a chip, a die, a substrate, etc.) configured to be wire bonded to device 300 (e.g., a substrate, a leadframe, a die/chip carrier, a chip, a die, etc.). For example, semiconductor device 302 may be a die that was previously die bonded to carrier 300 (e.g., leadframe/substrate 300). Clamp 304 is provided to hold device 300 (and device 302) in place. Clamp 304 defines aperture 304a. The area adjacent device 302 through aperture 304a is known as the bond site area as it is the area where the wire bonding operation occurs.

FIG. 3B illustrates other components of the wire bonding machine (with support/auxiliary structures removed for clarity) including capillary 14, electronic flame off wand 24, electronic flame off gas supply tube 18, and gas supply tube 20. Gas supply tube 20 may be a multi-part structure such as that shown in FIGS. 1-2, or it may be a unitary structure. In the event of a unitary structure, depending upon the application, the material may be metallic (e.g., stainless steel) or may be an insulative material (e.g., polyimide). At the process step shown in FIG. 3B, electronic flame off gas supply tube 18 is directing cover gas 28 towards the area where a free air ball is formed on a wire. Additionally, gas supply tube 20 is directing cover gas 26 in a generally downward direction.

FIG. 3C illustrates a process step where the various components (capillary 14, electronic flame off wand 24, electronic flame off gas supply tube 18, and gas supply tube 20) have been moved (e.g., either together or separately) into a position generally above bond site area 306. As shown in FIG. 3C, cover gas 26 is provided to bond site area 306 from above bond site area 306. Also shown in FIG. 3C is length of wire 30 hanging below the tip of capillary 14, and free air ball 32 formed on the end of wire 30 (e.g., formed by electronic flame off wand 24).

FIG. 3D illustrates the first bonding of ball 32 to semiconductor device 302 (e.g., ball 32 is bonded to a die pad on semiconductor device 302 which is not shown). As ball 32 is being bonded to semiconductor device 302, cover gas 26 reduces potential oxidation in bond site area 306. FIG. 3E illustrates the components (capillary 14, electronic flame off wand 24, electronic flame off gas supply tube 18, and gas supply tube 20) being raised upwards such that a length of wire 30 pays out of capillary 14. As wire 30 is being paid out of capillary 14, cover gas 26 continues to reduce the potential of oxidation in bond site area 306.

FIG. 3F illustrates the second bonding of the end of wire 30 to device 300 (e.g., the second end of wire 30 is bonded to a die pad on device 300 which is not shown). As the second end of wire 30 is being bonded to device 300, cover gas 26 continues to reduce the potential of oxidation in bond site area 306. After the bonding of the second end of wire 30 to device 300, wire loop 30a is completed between semiconductor device 302 and device 300.

FIG. 3G illustrates the components (capillary 14, electronic flame off wand 24, electronic flame off gas supply tube 18, and gas supply tube 20) raised upwards and a new length of wire 30 extending below the tip of capillary 14. As the components are raised upwards, cover gas 26 continues to reduce the potential of oxidation in bond site area 306. FIG. 3H illustrates a new ball 32 formed at the end of wire 30 using electronic flame off wand 24. For example, during formation of ball 32, cover gas 28 is provided to reduce potential oxidation during free air ball formation. As new ball 32 is formed, cover gas 26 continues to reduce the potential of oxidation in bond site area 306.

The process illustrated in FIGS. 3A-3H may be repeated as desired for the wire bonding operation.

The flow of cover gas (e.g., cover gas 26) from the gas supply tube (e.g., gas supply tube 20) may be a continuous flow of cover gas during the entire wire bonding operation. Alternatively, the flow may be a controlled flow (e.g., controlled using a controller integrated with the wire bonding machine) that is provided, for example, during periods of greatest concern regarding potential oxidation.

The drawings provided herein illustrate exemplary structures (e.g., gas supply tube 20) for directing a cover gas from above the bond site area to the bond site area; however, the invention is not limited thereto. The present invention contemplates any type of structure, system or process for providing cover gas to the bond site area from above (or substantially above) the bond site area.

When the present invention is used in connection with a wire formed of a reactive metal (e.g., copper, aluminum, etc.) the cover gas is desirably non-reactive with the metal and may be reducing. For example, the cover gas may be an effectively inert gas such as nitrogen or argon. A reducing gas (e.g., hydrogen) may be added to react with any oxygen that may be present; however, the cover gas system of the present invention may be utilized to exclude air from the bond site area without the need for hydrogen in the cover gas. This is a further advantage of the present invention because of the difficulties of using large quantities of highly flammable hydrogen.

The teachings of the present invention may also be utilized in connection with non-reactive bonding wire, such as gold wire. For example, the cover gas may be utilized to provide a shield of clean gas at the bond site area, thereby providing a desirable environment for formation of gold wire loops.

Although the present invention has been described primarily with respect to cover gases such as nitrogen and argon (with or without a forming gas such as hydrogen), it is not limited thereto. Any gas may be utilized so long as it does not react undesirably with the metal used as a bonding wire.

The processing techniques of the present invention may be implemented in a number of alternative mediums. For example, the techniques can be installed on an existing computer system/server as software (a computer system used in connection with, or integrated with, a wire bonding machine). Further, the techniques may operate from a computer readable carrier (e.g., solid state memory, optical disc, magnetic disc, radio frequency carrier medium, audio frequency carrier medium, etc.) that includes computer instructions (e.g., computer program instructions) related to the wire bonding techniques.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A wire bonding machine comprising:
a bond site area for holding a semiconductor device during a wire bonding operation; and
a gas supply line configured to provide a gas at the bond site area from above the bond site area.

2. The wire bonding machine of claim 1 wherein the gas supply line includes a tube with an outlet opening directed towards the bond site area.

3. The wire bonding machine of claim 2 wherein the tube is a unitary structure.

4. The wire bonding machine of claim 2 wherein the tube is a multi-part tube including an end portion defining the outlet opening.

5. The wire bonding machine of claim 4 wherein the end portion comprises polyimide.

6. The wire bonding machine of claim 2 additionally comprising a bond head for supporting the tube.

7. The wire bonding machine of claim 6 additionally comprising an electronic flame off wand and an electronic flame off gas supply line, the electronic flame off gas supply line being configured to provide a gas during formation of a ball on an end of a wire via the electronic flame off wand.

8. The wire bonding machine of claim 1 wherein the tube defines a bend along its length.

9. The wire bonding machine of claim 1 wherein the gas supply line is configured to provide the gas to reduce the potential for oxidation of the wire at the bond site area.

10. A wire bonding machine comprising:
a bond site area for holding a semiconductor device during a wire bonding operation;
an electronic flame off wand;
an electronic flame off gas supply line, the electronic flame off gas supply line being configured to provide a gas during formation of a ball on an end of a wire via the electronic flame off wand; and
a gas supply tube configured to provide a gas at the bond site area to reduce the potential for oxidation of a wire at the bond site area.

11. A method of processing a semiconductor device, the method comprising the steps of:
providing a wire bonding machine including a bond site area for holding a semiconductor device during a wire bonding operation; and
supplying a gas to the bond site area from above the bond site area during the wire bonding operation.

12. The method of claim 11 wherein the supplying step includes supplying the gas to the bond site area via a gas supply tube positioned above the bond site area.

13. The method of claim 12 further comprising supporting the gas supply tube using a bond head of the wire bonding machine.

14. The method of claim 11 wherein the supplying step includes supplying the gas to the bond site area to reduce the potential for oxidation of a wire at the bond site area.

15. The method of claim 11 further comprising bonding a wire loop between the semiconductor device and a carrier supporting the semiconductor device while the gas is being supplied to the bond site area.

16. The method of claim 11 further comprising bonding a wire to the semiconductor device while the gas is being supplied to the bond site area.

17. The method of claim 16 further comprising forming a ball at the end of the wire prior to the wire being bonded to the semiconductor device.

18. The method of claim 17 further comprising providing a gas to the end of the wire prior to the forming of the ball.

19. The method of claim 11 wherein the supplying step includes supplying the gas including at least one of nitrogen, argon, and hydrogen to the bond site area.

20. The method of claim 11 wherein the supplying step includes supplying the gas continuously through a sequence of (1) forming a free air ball at the end of a wire and (2) bonding the free air ball to the semiconductor device.

21. The method of claim 11 wherein the supplying step includes supplying the gas continuously through a sequence of (1) forming a free air ball at the end of a wire, (2) bonding the free air ball to the semiconductor device, and (3) bonding the other end of the wire to a carrier supporting the semiconductor device.

22. The method of claim 11 wherein the supplying step includes supplying the gas continuously through a sequence of (1) forming a free air ball at the end of a wire, (2) bonding the free air ball to the semiconductor device, (3) bonding the other end of the wire to a carrier supporting the semiconductor device, and (4) forming another free air ball after bonding of the other end of the wire to the carrier.
